(19) United States
(12) Patent Application Publication
(10) Pub. No.: US 2006/0287911 A1
(43) Pub. Date: Dec. 21, 2006

(54) COMPETITIVE USABILITY ASSESSMENT SYSTEM

(75) Inventors: Jason C. Laberge, Lauderdale, MN (US); John R. Hajdukiewicz, Minneapolis, MN (US); Yong Ming Kow, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/160,372

(22) Filed: Jun. 21, 2005

(51) Int. Cl. G06F 11/34

(52) U.S. Cl. 705/11

(57) ABSTRACT

An assessment system utilizing usability engineering and six sigma. An assessment may involve task analysis incorporating process maps or the like. This analysis may be extended into a development of user interface (UI) maps. Information about customer needs may be obtained from a voice of the customer (VOC). This information may be used in a failure mode and effects analysis (FMEA) table. Usability engineering may be used to analyze usability data. Results may include usability problems and positive features enterable into the FMEA table. Usability profiles may be drawn from information and ratings in the FMEA table. A quality function deployment (QFD) may be used to prioritize usability findings with reference to the FMEA table. There may be a strengths, weaknesses, opportunities and threats (SWOT) analysis. Affinity diagrams, used to categorize information from usability profiles, the QFD, the SWOT and the FMEA table, may provide design direction for successor applications.

### BACKGROUND

The present invention pertains to usability, and particularly to usability engineering. More particularly, the invention pertains to usability assessment.

### SUMMARY

The invention is a system that may include usability engineering, product/application analysis, and/or competitive assessment.

### BRIEF DESCRIPTION OF THE DRAWING

FIG. 1 is a diagram of an overall competitive usability assessment system;

FIG. 2a reveals a flow chart of a competitive usability assessment approach;

FIG. 2b shows illustrative units of an integrated, technical system for competitive usability assessments;

FIG. 3 is a block diagram of the customer needs in the context of the present approach;

FIG. 4 is an illustrative example of a failure mode and effects analysis spreadsheet or table;

FIGS. 5a and 5b show usability areas relative to a percentage of problems and average risk priority, respectively;

FIGS. 6a and 6b show usability heuristics relative to a percentage of problems and average risk priority, respectively; and

FIG. 7 is a chart showing a strengths, weaknesses, opportunities and threats analysis from competitor usability assessments.

### DESCRIPTION

The present system may be a quantitative approach to competitive usability assessment that combines both usability engineering and other approaches such as “Six Sigma™”. Six sigma, variants of six sigma, and equivalent approaches may be referred to herein as “six sigma”. Usability engineering is a systematic approach to making something (e.g., system, device or software) easier to use for individuals who actually use it. A system, device or software may be tested by individuals who are typical users or evaluated by a set of persons who examine and judge the system, device or software with recognized usability principles (i.e., heuristics). Six sigma may be regarded as a disciplined, data-driven approach, metric, methodology and/or a management system. As a metric, it may be used for eliminating defects (driving towards six standard deviations between the mean and the nearest specification limit). As a methodology, it may aid in understanding and managing customer requirements, aligning key businesses processes to achieve the requirements, utilizing rigorous data analyses to minimize variation in those processes, and driving rapid and sustainable improvement to business processes. Six sigma may be used to define opportunities, measure performance, analyze opportunities, improve performance, and control performance (viz., DMAIC). As a management system for executing business strategy, it may aid in aligning business strategy, mobilizing teams to attack high impact projects, accelerating improved business results, and governing efforts to ensure attained improvements are sustained.

The technical approach described herein may be useful for helping a product development team compare company software tools to the competition in terms of usability problems that occur, the features available, and the user tasks that are supported. This information may also be helpful for determining product requirements and strategy, project scope, and design direction.

A goal of competitive assessment may include understanding the strengths and weaknesses of a product or application relative to the competition. Traditional competitive usability assessments often rely on objective comparisons such as task completion rate, task time, errors, and subjective questionnaire data. However, usability may be a multi-dimensional construct that is associated with a product that is easy to learn, efficient to use, easy to remember, produces few errors, and is subjectively pleasing. Therefore, any technique that evaluates the usability of a product should consider more than one aspect of usability. Traditional objective measures may be limited because meaningful comparisons between competitors are difficult to make since it is unclear which dimension of usability is contributing to the findings. Similarly, it may be challenging to know which features or area of an application or product to focus on when making it more favorably usable. The technical approach described herein addresses many of these limitations.

An entity utilizing the present usability assessment system may be referred to as a “company”. The key aspects of the quantitative approach to competitive usability assessment, among other items, may include: quantified usability findings and profiles of each competitor of the company (including findings and profiles of the company) using the present approach to show the strengths and weaknesses; identified opportunities for improvement for multiple development efforts that could differentiate the company from the competition; and design concepts with potential intellectual property for the present and next generation products (e.g., hardware, software, and so forth).

The company team may use an integrated approach to a competitive usability assessment which leverages six sigma tools and combines them with approaches, methods and practices from the field of usability engineering. More specifically, the approach may integrate qualitative usability findings obtained using usability engineering approaches and methods; relate the findings to the customer needs obtained from voice of the customer (VOC) activities, usability area and heuristics (i.e., design guidelines), and common user tasks identified via process maps; and assign numerical ratings to quantify the impact of each finding on the user experience.

An example use of the competitive usability assessment system may be that the company's business unit has identified that low usability, for example, of its tools or products, results in higher costs to engineer the company's control systems versus the competition. An illustrative example may be an automation tool. As a result, the company's bids may include significantly more labor hours than its competitors. A purpose of the present usability assessment system may include comparing the usability of the company's automation tools with its competition and to embed software usability in the next generation of tools. Additional benefits of the usability assessment system may include improved efficiencies with installation and service delivery to improve competitiveness and provide the lowest total installed cost per product by the company business unit.

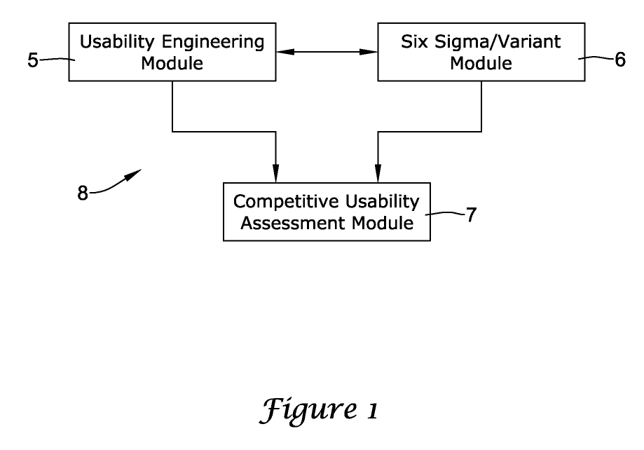

FIG. 1 is a diagram of an overall usability assessment system 8. The system 8 may include a usability engineering module 5 and a six sigma/variant module 6 connected to each other. Modules 5 and 6 may have outputs connected to a competitive usability assessment module 7. Module 7 may be regarded also or instead as a competitive assessment module.

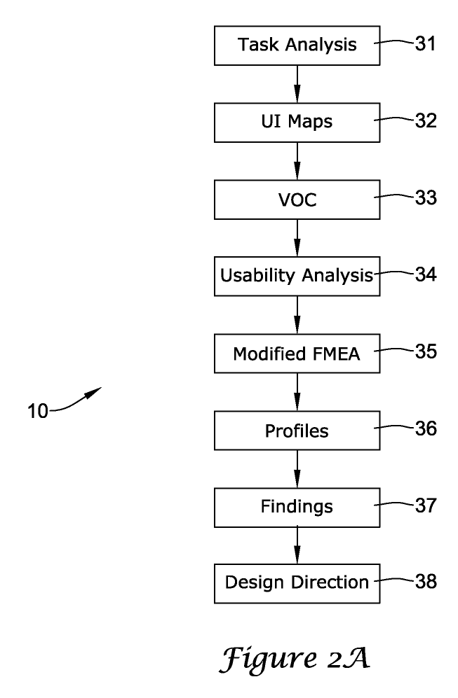

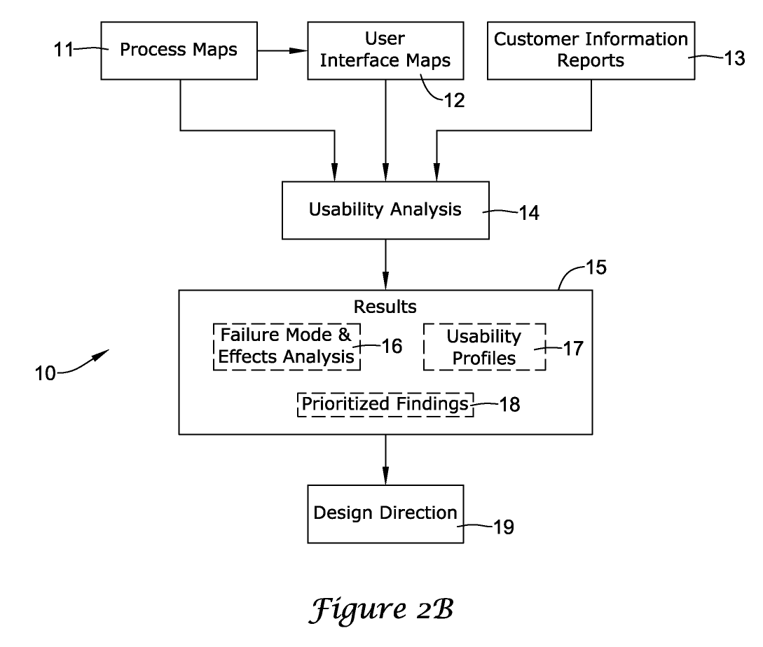

FIGS. 2a and 2b show a modularized eight step approach to complete a competitive usability assessment, and illustrative units of an integrated, technical system 10 for competitive usability assessments, respectively. In FIG. 2a, there is a flow chart of the competitive usability assessment having a task analysis 31, user interface maps 32, VOC (voice of customer) 33, usability analyses 34, a modified FMEA (failure mode and effect analysis) spreadsheet 35, profiles 36, prioritized findings 37, and design direction 38. It may be referred to as a competitive usability assessment system 10. A first step may be a task analysis. This may involve identifying the competitors and doing a task analysis for each competitor. It may be significant that a task analysis be completed to document what a user actually does with each, for an illustrative example, software application. However, the format of the results of the task analysis may be different. Process maps 11 may be used in a format common to six sigma. Alternate formats may include task lists, task hierarchies, and so forth. A process map 11 may show user tasks, steps, inputs/outputs, user(s), and decisions needed to use the application. A purpose of the process map 11 may include understanding the differences of the steps and the overall workflow for each application. Example user tasks for a process map 11 may include initializing the project, hardware definition, direct digital control (DDC) programming, network management, scheduling, downloading, testing/checkout, balancing/calibration, and graphics engineering.

Each process map may be compared and it may be common that there are substantial differences between the competitors. This may make it difficult to compare the applications based on the dissimilar tasks, steps, and decision points. Therefore, a common work process map may be developed that captures the similar user tasks supported by all of the applications. This may be important because it shows the common tasks that are supported to greater or lesser degrees relative to the competition.

Another unit, module or stage, may include user interface (UI) maps 12. In this unit, the analyst may look at the individual screen elements (rather than user tasks). This may be a natural extension of the task analysis albeit with more focus on screen details. It may be significant to look at the individual screen elements for each application but the results could be captured in different ways. UI maps may be used to do this, and this may be a significant form. A user interface map 12 may be based on a task analysis. Screen shots may be captured to show the applications that support the user tasks identified in the work process maps. The purpose of this unit may be to document how users traverse the application screen and how the features are implemented.

Another unit, module or stage may be a “voice of a customer” (VOC) or customer information reports 13. Here, an analyst may capture information about the customer needs. This may be done using various methods including surveys, interviews, focus groups, and so forth. A relevant finding may involve listening to the customer and hearing that the company's product has low usability. This finding alone may warrant a competitive usability assessment. Example factors that contribute to the usability of the product and the satisfaction of the customer needs may include training, situation awareness, end user confidence, productivity, flexibility, quality, and so forth.

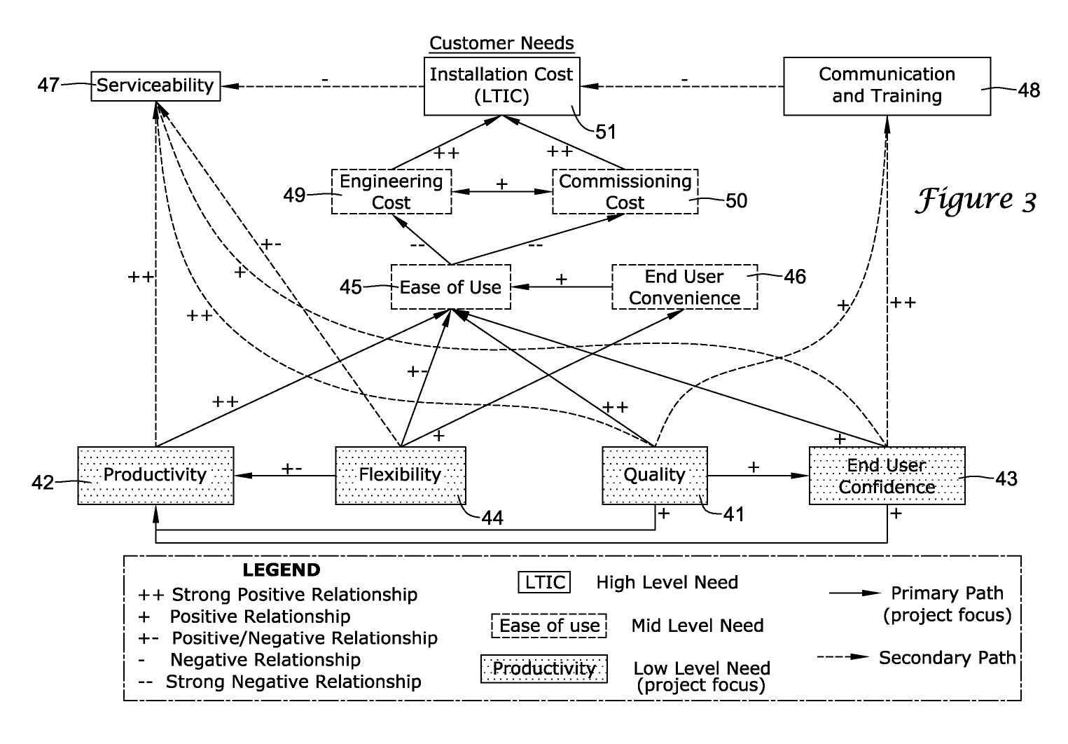

The results of a VOC gathering may be represented by using a conceptual map of how the customer needs are related. This information may be used in a modified FMEA by relating each observed usability problem to the customer need that was most affected. FIG. 3 is a block diagram relating to a customer's needs in the context of the present approach. The top row shows the high level needs, the middle rows show mid level needs and the bottom row shows low level needs. The various needs may be connected with primary (project focus) and secondary paths. Each path may have a relationship evaluation designation such as a “++” for a strong positive relationship, “+” for a positive relationship, “+−” for a positive/negative relationship, “−” for a negative relationship, and “−−” for a strong negative relationship. One may begin with the low level needs. Quality 41 may have a + primary path to productivity 42. End user confidence 43 may have a + primary path to productivity 42. Flexibility 44 may have a +− primary path to productivity 42. Quality 41 may have a + primary path to end user confidence 43. Productivity 42 may have a ++ primary path to ease of use 45. Flexibility 44 may have a +− primary path to ease of use 45 and a + primary path to end user convenience 46. Quality 41 may have a ++ primary path to ease of use 45. End user confidence 43 may have a + primary path to ease of use 45. Productivity 42 may have a ++ secondary path to serviceability 47. Flexibility 44 may have a +− secondary path to serviceability 47. Quality 41 may have a ++ secondary path to serviceability 47 and a + secondary path to communication and training 48. End user confidence 43 may have a + secondary path to serviceability 47 and a ++ secondary path to communication and training 48. End user convenience 46 may have a + primary path to ease of use 45. Ease of use 45 may have a −− primary path to engineering cost 49 and a −− primary path to commissioning cost 50. Engineering cost 49 may have a + primary path to commissioning cost 50. Commissioning cost 50 may have a + primary path to engineering cost 49. Engineering cost 49 may have a ++ primary path to installation cost (LTIC) 51. Commissioning cost 50 may have a ++ primary path to installation cost 51. Installation cost 51 may have a − secondary path to serviceability 47. Communication and training 48 may have a − secondary path to installation cost 51.

Usability analyses 14 may constitute a unit, module or stage. Standard usability engineering methods may be used to analyze usability data. There may be three different methods used, though one may suffice for gathering competitive assessment data. A difference here is that one also may analyze positive features/usability findings. The choice of usability method(s) used may be made based on the availability of users, competitive applications, and project schedule considerations. One may gather usability findings using heuristic analysis, walkthroughs, and/or usability testing methods.

A primary evaluation approach may be heuristic analysis. This approach may rely on the judgment of expert evaluators as the source of feedback regarding user-interface elements of each application. For instance, about three evaluators may inspect each competitor independently and record the usability problems they encountered. Users in an actual sense are not necessarily needed. In a general sense, heuristic evaluation may involve a small set of evaluators to examine the user interface and judge its compliance with recognized usability principles.

Walkthroughs may be another approach used. This technique may be used for gathering usability feedback from both end users and product developers. Screen shots from the UI maps 12 of each application may be presented and participants may respond verbally (thinking aloud) to each screen, and usability findings may be noted by observers.

An additional approach may include field-based usability tests to be completed whereby participants are given a common scenario from which to work and usability problems are recorded by test observers.

A unit, module or stage may include integrating the results 15 of the usability analyses into an FMEA 16 spreadsheet or table. Each usability problem may be treated as a failure mode, and also the positive features that are discovered may be included. A team may as a group aggregate usability findings (problems and features) into the FMEA spreadsheet and reach a consensus on the findings/ratings and assign each to a usability area, heuristic, and user task from the task analysis. Unique findings may be represented as a single row in the spreadsheet. The spreadsheet may contain a number of columns, which allow the evaluators to sort, analyze, and aggregate the data using a number of metrics and dimensions. This format makes it easy to make comparisons on different dimensions of usability.

The metrics and dimensions of the FMEA matrix 16 spreadsheet may include: owner (name of observer or evaluator, used for clarification purposes); source (heuristic evaluation, walkthrough, usability test); problem summary (one or two sentences describing problem); problem description (detailed explanation of problem); consequence (effect of problem on user); suggestion for improvement (one or two suggestions to mitigate problem); usability area (access, content, format, functionality, navigation, organization, symbols, terminology, workflow); usability heuristic (compatibility, consistency, error prevention and correction, flexibility and control, informative feedback, user guidance and support, visual clarity); user task from detailed process map (unique to the application); user task from common process map (common for all applications); screen reference (hyperlinks to screen shots from UI maps); severity of problem (1=mild, 3=moderate, 9=severe); probability of occurrence (1=0-33%, 3=34-66%, 9=66-100%); probability of detection (1=66-100%, 3=34-66%, 9=0-33%); and risk priority (i.e., a product of severity, occurrence and detection).

The spread sheet may list the findings by number down a far left column and the dimensions to be noted in a row across the top of the sheet. The dimensions may include item number, source, finding, area, criteria, customer need, process, unified process, screen reference, severity, probability of occurrence, probability of detection, risk priority, absolute value risk priority, description, consequence, and suggestion. There may be more, less or different dimensions of those listed here. A source may be the method used to discover the finding, such as heuristic analysis, walkthrough, or usability test data, as an example. An example finding may be a problem inconveniencing a user or preventing an accomplishment of a task with the product.

A usability area may include terminology, workflow, navigation, symbols, access, content, format, functionality, or organization. Usability heuristics may include visual clarity, consistency, compatibility, informative feedback, flexibility and control, error prevention and correction, and user guidance and support. A customer need may be quality, flexibility/modularity, productivity/efficiency, or end user confidence, as an example. A process may be a test controller, a backup project, a define time program, a develop project, or other, as an example. Common processes may be testing/diagnostic, scheduling, network management, initialize project, hardware definition, or programming, as an example. A screen reference may be a hyperlink to a screen shot of a project backup dialog box, control strategy screen, menu bar, or device library feature, as an example.

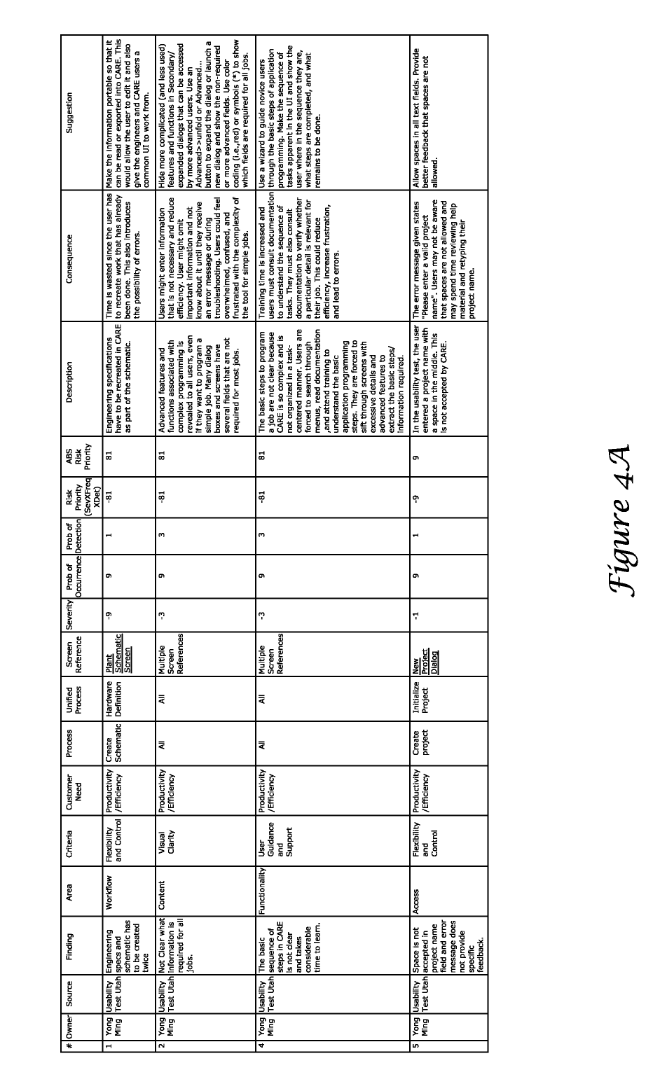

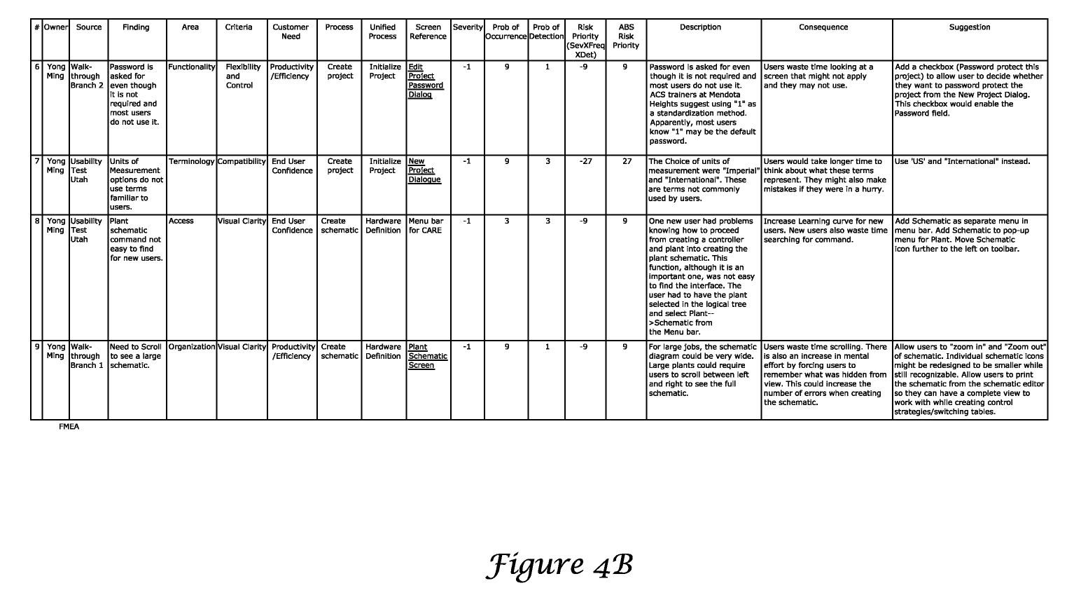

Severity may be rated with a number from −1 to −9, or other quantitative measure, as an example. Probability of occurrence may be rated with a number from +1 to +9, or other quantitative measure, as an example. Probability of detection may be rated from +1 to +9, or other quantitative measure, as an example. The risk priority may be a product of the three previously mentioned quantitative measures. An example may be “−2×5×8=−80”. The absolute risk priority may be the absolute value, for example, |−80| or 80. An example of a description, e.g., problem, may be “The user can only view one control strategy at a time when testing.” An example of a consequence of the problem may be “Users have to infer that the other strategies are working properly based on how the points react to their inputs.” An example of a suggestion to the problem may be “Allow users to open all strategies in one screen or multiple windows.” FIG. 4 shows a layout of an example FMEA table, matrix or spreadsheet.

Another unit, module or stage may include constructing usability profiles 17. One may use a pivot table function in, for example, Microsoft Excel™, to put together graphical usability profiles for each software application analyzed. The profiles may be formed based on the ratings and dimensions in the FMEA table. As an example, the results from the modified FMEA matrix 16 may be extracted into profiles for usability areas, usability heuristic, and common user tasks. Usability profiles may be developed using two metrics—the proportion of problems and the average risk priority. The proportion of problems may show where the majority of problems occur and be useful because it normalizes the data for the number of problems that are found. This may be significant because the same amount of time may not be spent evaluating each competitor product. The average risk priority for each problem may show where problems with the greatest overall consequence occur. The average risk priority may be calculated by multiplying the severity, occurrence, and detection ratings together. It may imply that severe problems, which occur more frequently and are difficult to detect, are considered more important relevant to usability. The graphical profiles may help the company team zone in on key problem areas for each, for instance, software tool or product. Example problem areas may relate to inconsistency in a product, lack of workflow support, and awkward functionality. The usability profiles may be useful for high-level comparisons, yet the FMEA spreadsheet may be available to review more detailed problems and suggestions. This format for summarizing usability findings may be significantly different from other approaches.

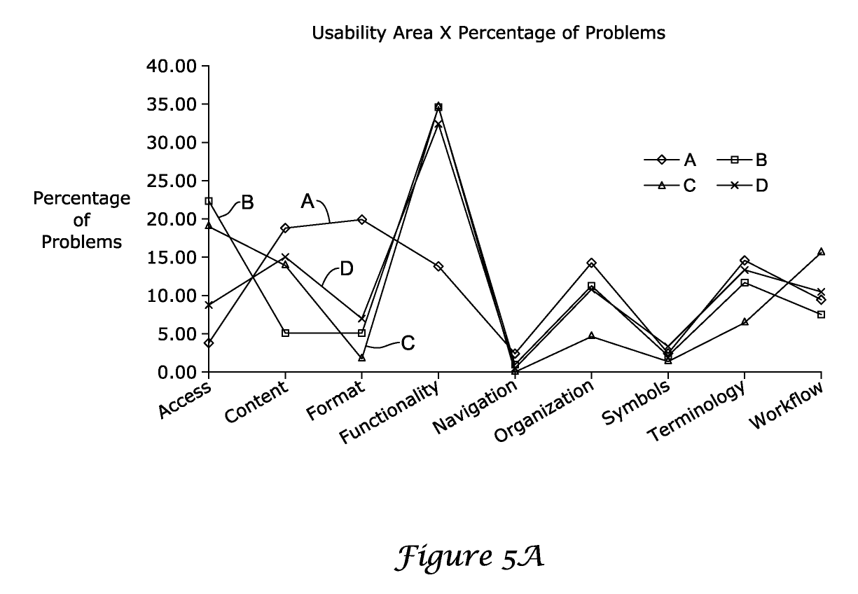

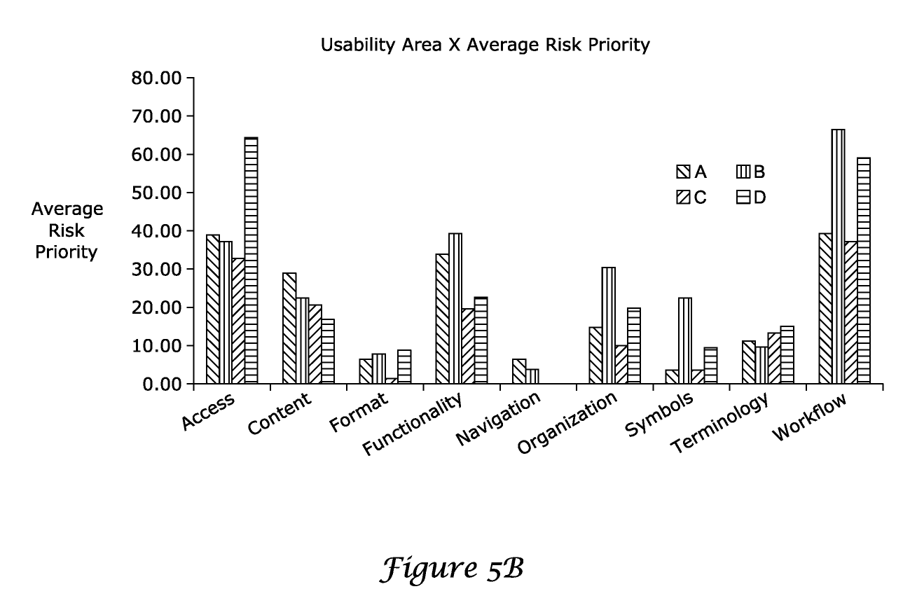

FIGS. 5a and 5b show example profiles for usability areas relative to a percentage of problems and average risk priority, respectively. The graphs of these Figures may represent an evaluation of four building automation tools of companies A, B, C and D (including several competitors and the present company, although all of the tools may be referred to as competitors), respectively, as a part of ongoing competitive assessments. FIG. 5a shows the profile of each competitor's tool as a function of the usability area where the percentage of the problems occur. It appears that for the tools of competitors B, C, and D, most of the problems were functionality related. The tools of competitors B and C also appeared to have problems with easy access to information. For the competitor A tool, the findings seemed more evenly distributed across the problem areas of content, format, organization, and terminology.

FIG. 5b shows a different pattern when the problems are examined in terms of where the greatest overall risk occurs. It appears that the competitor D tool had the greatest risk associated with the access and workflow areas. Thus, although competitor D tool seems to have a small proportion of problems associated with access in FIG. 5a, those problems may be considered to be high risk according to FIG. 5b. The tools of competitors A and B appeared to show high risk with regards to access, functionality and work flow.

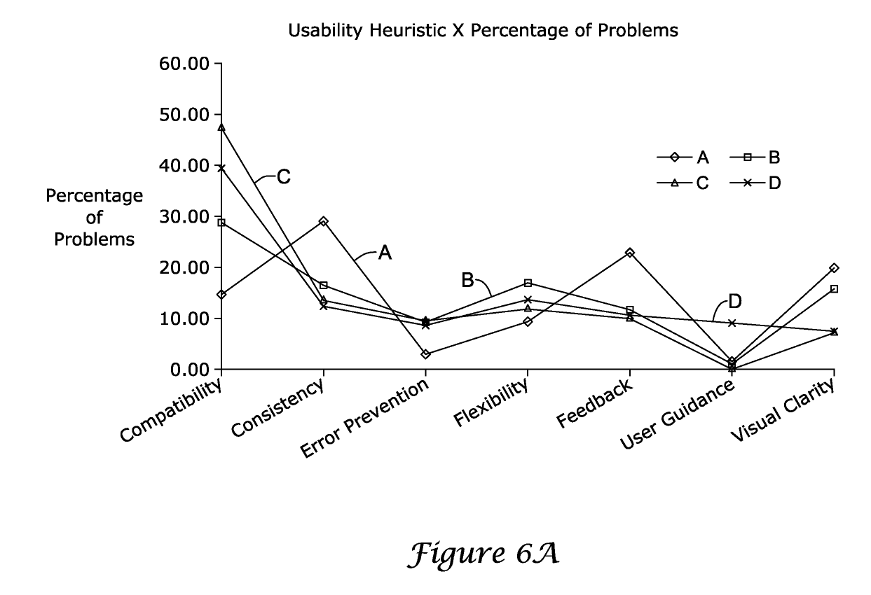

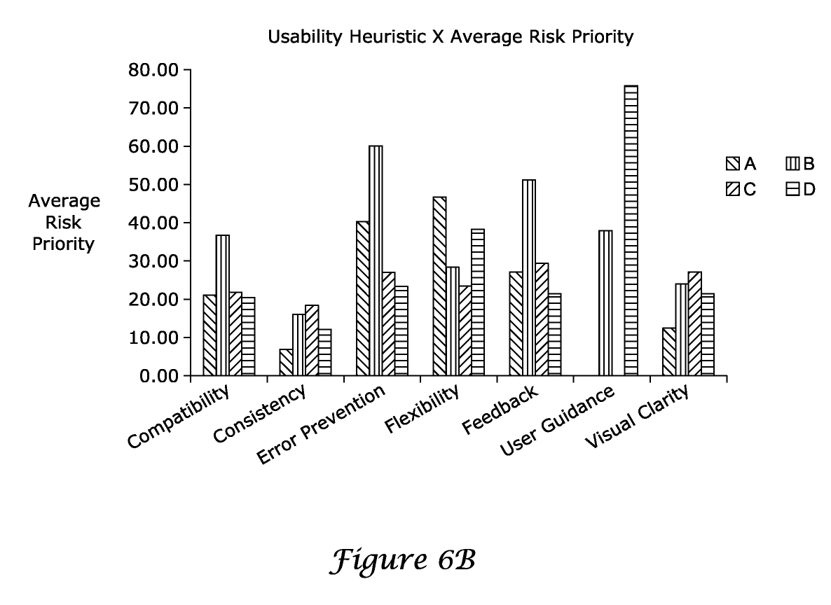

FIGS. 6a and 6b show the percentage of problems versus usability heuristics, relative to the percentage of problems and the average risk priority, respectively. These Figures may be helpful for identifying the aspects of usability that lead to difficulties experienced by users. It appears that the tools of the companies B, C and D had some problems with compatibility (FIG. 6a). The competitor A tool also showed more problems with consistency and providing informative feedback than the other tools. The competitors' tools appear relatively similar for the other usability heuristics.

FIG. 6b shows that the competitor B tool appears to have the problems with the greatest risk overall and to be higher in terms of compatibility, error prevention, and feedback than the other tools. The competitor D tool appears to have severe problems related to user guidance whereas the competitor A tool showed the most risk in terms of flexibility.

Usability results may also be prioritized. A QFD (another six sigma tool) may be used to prioritize the findings. QFD may be a systematic process for motivating a business to focus on its customers and their needs (including usability). It may be used by cross-functional teams to identify and resolve issues involved in providing products, processes, services and strategies which will more than satisfy their customers. The application of the QFD (quality function deployment) may be different from others as the ratings in the FMEA table are used to prioritize the results and show which usability area, heuristic, and customer needs were associated with the greatest risk due to the observed usability problems. It may be more common to use subjective group ratings in a QFD. Results of a QFD analysis may include findings 18 that may be prioritized.

One may use profiles and QFD analysis to prioritize findings based on their impact on the customer needs. The findings 18 that impact the important usability areas, heuristics, and user tasks, may be identified. A design direction may emerge based on the usability profiles, QFD, and detailed FMEA results. The findings may be categorized based on affinity diagrams. The affinities may make it clear which design direction and features to focus on for the next generation of company products. Using affinity diagrams to categorize large amounts of data may be a practice in the fields of usability engineering and six sigma. Design direction 19 may focus on standard features such as consistent style and conventions, and application-specific features such as offline simulation and a device library feature that may help with product differentiation and intellectual property. One may also extract specific product requirements. Profiles and detailed problems may be analyzed to determine how usability can be improved relative to the competition. A usability team may analyze the profiles and develop specific product requirements that address the areas and heuristics that are deemed the most important for usability. The team may also consider the usability areas and heuristics in which the competition excels.

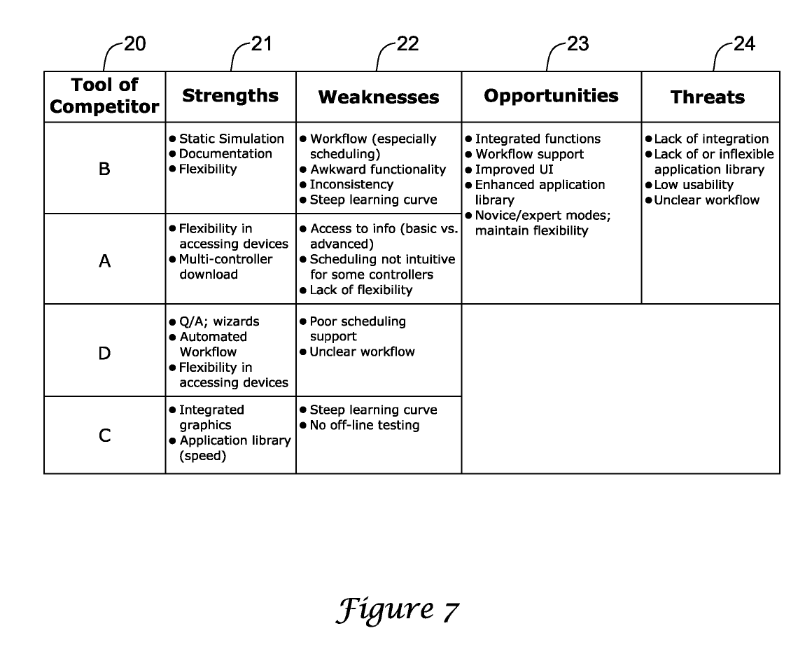

Numerous issues may be identified and summarized relative to the tools of competitors A, B, C and D. FIG. 7 is a chart showing a SWOT (viz., strengths, weaknesses, opportunities and threats) analysis from competitor usability assessments. Particularly, the chart shows a competitor tool column, strengths column 21, weakness column 22, opportunities column 23 and threats column 24. The SWOT analysis is an example summary of such findings after an integration of results from the modified FMEA 16 analysis and usability profiles 17. This SWOT analysis may show the company's strengths and weaknesses relative to the competition, and key areas for improvement. The analysis also may provide sales and marketing with insights on how the company can compete at the present time, and may provide product development and technology strategy with insights on what to improve. The results may be used by the company development teams to prioritize requirements. One may note that the tools of competitors A and B may be those of the present company.

A summary of the SWOT chart for the competitor A tool, the strengths may include flexibility in accessing devices and a multi-controller download, and the weaknesses may include access to information, scheduling not intuitive for some and a lack of flexibility. For the competitor B tool, the strengths may include static simulation, documentation and flexibility, and the weaknesses may include workflow, awkward functionality, inconsistency and a steep learning curve. For the competitor D tool, the strengths may include questions/answers, automated workflow, and flexibility in accessing devices, and the weaknesses may include poor scheduling support and unclear workload. For the competitor C tool, the strengths may include integrated optics and application library (i.e., speed), and the weakness may include a steep learning curve and no off-line testing. Opportunities for the tools of competitors A and B may include integrated functions, workflow support, improved UI, an enhanced application library, and novice/expert modes to maintain flexibility. The threats for the tools of the competitors A and B may include lack of integration, lack of or inflexible application library, low usability and unclear workflow. Opportunities and threats were not noted for the tools of the outside competitors C and D of the company.

In summary, the present approach or system may be useful for collating and comparing usability data for the purpose of competitive analyses. By having all the findings in one FMEA spreadsheet, the results may be easily converted into profiles based on a proportion of problems and average risk priority. The findings can also be summarized using a SWOT to show the strengths and weaknesses of each tool and the functions that are available. This system may help a team extract product requirements that ensure that the next generation of products or software applications is usable, meets user needs, and is competitive.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. An assessment system comprising:
a usability engineering module;
a six sigma module connected to the usability engineering module; and
a competitive usability assessment module connected to the usability engineering module and the six sigma module.

2. The system of claim 1, wherein the six sigma module comprises defining opportunities, measuring performance, analyzing opportunities, improving performance and/or controlling performance.

3. The system of claim 2, wherein the usability engineering module comprises reviewing and/or examining in the context of usability principles.

4. A usability assessment system comprising:
a process map stage;
a user interface map stage connected to the process map stage;
a customer information stage;
a usability analysis stage connected to the process map, user interface map and customer information stages; and
a results stage connected to the usability analysis stage.

5. The system of claim 4, wherein the results stage comprises:
a failure mode and effects analysis unit;
a usability profiles unit;
a strengths, weaknesses, opportunities and threats analysis unit; and
a prioritized findings unit.

6. The system of claim 5, further comprising a design direction unit connected to the results stage.

7. The system of claim 6, wherein the design direction uses usability profiles, quality function deployment, failure mode and effect analysis results, and/or strengths, weaknesses, opportunities and threats analysis.

8. The system of claim 6, wherein the design direction uses affinity diagrams to categorize data from process maps, user interface maps, customer information, usability profiles, failure mode and effects analysis results, and/or prioritized findings.

9. An assessment method of a system comprising:
performing a task analysis for the system using a process map;
obtaining customer information about the system;
doing a usability analysis;
capturing results of the usability analysis using a failure mode and effects analysis (FMEA) table;
doing a strengths, weaknesses, opportunities and threats analysis; and
prioritizing the findings based on the results using a quality function deployment (QFD).

10. The method of claim 9, further comprising providing usability profiles from the FMEA table.

11. The method of claim 10, further comprising providing design direction from the usability profiles, the QFD, the FMEA table, and/or the strengths, weaknesses, opportunities and threats analysis.

12. The method of claim 11, further comprising extending the task analysis to provide user interface maps.

13. The method of claim 11, further comprising using affinity diagrams to categorize the findings.

14. A system for competitive assessment comprising:
performing a task analysis to document the tasks a user does relative to a software application;
entering the tasks in a process map;
extending the task analysis to user interface (UI) maps from focusing on the screen elements of the application;
obtaining customer needs information (VOC) relative to the application;
using the customer needs information in a failure mode and effect analysis table to relate each usability problem to a customer need that is most affected to obtain usability data; and
analyzing usability data to obtain competitive assessment data.

15. The system of claim 14, further comprising:
entering each usability problem of the usability data as a failure mode in a failure mode and effect analysis (FMEA) table;
entering positive features of the usability data in the FMEA table;
developing ratings of the usability data in the FMEA table; and
developing usability profiles for the software application from ratings in the FMEA table.

16. The system of claim 15, further comprising prioritizing usability findings based on ratings in the FMEA table.

17. The system of claim 15, further comprising prioritizing the usability findings with a QFD and ratings in the FMEA table.

18. The system of claim 17, wherein the prioritizing the findings indicate which usability area, heuristic and/or customer needs are associated with the greatest risk.

19. The system of claim 16 further comprising categorizing the findings with affinity diagrams.

20. The system of claim 19, wherein affinities of the affinity diagrams indicate a design direction.
